(19) United States
(12) Patent Application Publication
(10) Pub. No.: US 2012/0111829 A1
(43) Pub. Date: May 10, 2012

(54) METHOD FOR PRODUCTION OF A DEVICE WITH A GRAPHICAL ELEMENT

(75) Inventors: Chrystel Deguet, Grenoble (FR); Alain-Marcel Rey, Mours St Eusebe (FR); Thomas Signamarcheix, Grenoble (FR)

(73) Assignee: COMMISSARIAT A I'energie atomique et aux ene alt, Paris (FR)

(21) Appl. No.: 13/384,035

(22) PCT Filed: Jul. 20, 2010
(86) PCT No.: PCT/EP2010/060456

§ 371 Date: Jan. 13, 2012

(30) Foreign Application Priority Data
Jul. 22, 2009 (FR) 0955124

(51) Int. Cl. B32B 37/02; B32B 37/14; B32B 38/10

(52) U.S. Cl. 216/33; 156/247

(57) ABSTRACT

A method for producing a device, with a graphical element, including: a) producing a stack including at least one sacrificial layer positioned between a first substrate and a protective layer, and a graphical element produced in a first face of the protective layer opposite a second face of the protective layer, such that the second face is positioned against the sacrificial layer; b) attaching the stack to at least one second substrate such that the graphical element is positioned between the first substrate and the second substrate; and c) separating the sacrificial layer from the protective layer.

### TECHNICAL FIELD

The invention concerns a method to produce a device with a graphical element. The invention notably enables one or more devices to be produced, which are able to be produced collectively, and including graphical elements of microscopic and/or nanoscopic dimensions, representing for example data such as text and/or images and/or illustrations, embedded within one or more massive objects in the form of thumbnail images which may include one or more transparent windows through which they can be seen.

The invention notably enables an object to be marked, for example with a decorative aim and/or with an aim of identification, or again of traceability, such as a jewel, a face of a watch, a window of a screen of an item of electronic equipment, a precious or semiprecious stone, or any object of high added value, or with stringent requirements in respect of security (safety parts of a vehicle or elements in the medical field such as prostheses).

### STATE OF THE PRIOR ART

In order to authenticate an original product it is for example known to etch identification data on the product in question, by using techniques derived from microelectronics, for example by photolithography and etching of the product.

It is also known to produce objects including decorations or artwork of micrometric size through use of these same techniques.

However, the durability and mechanical robustness of these decorations or identification data produced on the surface of the objects are generally mediocre.

Document U.S. Pat. No. 5,972,233 A describes a method of production of a graphical element for a jewel, in which a substrate is etched with the pattern of the graphical element. A reflective layer is positioned against a first face of the substrate, which is then attached, in a second face opposite the first face, with a jewel.

In this case also, the durability and mechanical robustness of such a graphical element are not satisfactory.

### ACCOUNT OF THE INVENTION

One aim of the present invention is to provide a method of production of a device with a graphical element enabling a surface, which may for example be flat, of an object to be personalised through the addition of an embedded and protected graphical element, and which is therefore tamper-resistant (impossible to forge), and which does not have the disadvantages of the prior art.

To this end, the present invention provides a method of production of a device with a graphical element, including at least the following steps:

a) production of at least one stack including at least one sacrificial layer positioned between at least one first substrate and at least one protective layer, and at least one graphical element produced in a first face of the protective layer opposite a second face of the protective layer, such that said second face is positioned against the sacrificial layer,

b) attachment of said stack to at least one second substrate such that the graphical element is positioned between the first substrate and the second substrate,

c) separation of the sacrificial layer from the protective layer.

By this means, it is possible to produce a device with a graphical element (artwork and/or texts and/or identification elements) including microscopic and/or nanoscopic patterns, enabling very large quantities of data and/or decorative elements to be encapsulated in a durable, unalterable and tamper-proof manner due to the protection provided by the protective layer protecting against the outside environment.

This method enables a graphical element to be transferred on to an object, called a second substrate, without distorting it, bearing in mind the thinness of the protective layer, which is, for example, between approximately 100 nm and 100 μm thick.

The graphical element may be produced, in the course of step a), by etching at least the first face of the protective layer with a pattern of the graphical element. Thus, the graphical element is formed by hollows made by etching in the first face of the protective layer.

In this case, step b) of attachment may comprise a molecular bonding of the protective layer against the second substrate, implemented under a vacuum. Such a molecular bonding notably enables a device to be obtained having excellent thermal properties.

In addition, the protective layer may be made from an oxide, for example silicon oxide, or from silicon nitride, where the second substrate can include a face made from an oxide, for example silicon oxide, or silicon nitride, and where the protective layer and the second substrate can be bonded molecularly to one another, in the course of step b), in the first face of the protective layer and of said face of the second substrate.

Step a) of production of the stack may include implementation of the following steps:
production of a stack including the sacrificial layer positioned between the first substrate and the protective layer, and a layer which is intended to form the graphical element positioned against the first face of the protective layer,
etching of the layer which is intended to form the graphical element with a pattern of the graphical element, where the remaining portions of said etched layer form the graphical element,
deposition of a layer covering the protective layer and the graphical element,
planarisation of the layer covering the protective layer and the graphical element.

The layer which is intended to form the graphical element may be made from a material which is at least partially opaque to visible light, and/or visible in infrared and/or ultraviolet light.

In another variant, step a) of production of the stack may include implementation of the following steps:
production of a stack including the sacrificial layer positioned between the first substrate and the protective layer, and a mask layer positioned against the first face of the protective layer,
etching of the mask layer with a pattern which is the reverse of the pattern of the graphical element,
deposition of a material on the first face of the protective layer through the etched mask layer, forming the graphical element,
elimination of the etched mask layer,
deposition of a layer covering the protective layer and the graphical element,
planarisation of the layer covering the protective layer and the graphical element.

Step b) of attachment may include a molecular bonding of the layer covering the protective layer and the graphical element against the second substrate.

Such a molecular bonding notably enables a device to be obtained having excellent thermal properties.

The layer covering the protective layer and the graphical element may be made from a dielectric material.

The layer covering the protective layer and the graphical element may be made from an oxide, for example silicon oxide, or from silicon nitride, where the second substrate may include a face made from an oxide, for example silicon oxide, or silicon nitride, and where the layer covering the protective layer and the graphical element, and the second substrate, may be bonded molecularly to one another, in the course of step b), at the level of said face of the second substrate.

Step c) of separation may include an application of a mechanical stress between the sacrificial layer and the protective layer, and/or, when the first substrate is made from an at least partially transparent material, and the sacrificial layer from at least one material able to disintegrate, a laser irradiation of the sacrificial layer through the first substrate, and/or, when the sacrificial layer is made from a fusible material, a thermal treatment at a temperature higher than or equal to the melting point of said fusible material, and/or a chemical attack by a solution able to disintegrate the material of the sacrificial layer.

The protective layer and/or the second substrate may be made from at least one optically transparent material. Thus, it is possible to see the graphical element through the protective layer and/or through the second substrate.

It is also possible that neither the protective layer nor the second substrate is made from an optically transparent material. In this case it is, for example, possible that the material of the protective layer and/or the material of the second substrate are chosen so as to be able to read the graphical element, for example by infrared or ultraviolet radiation, where these materials are, for example, silicon.

Steps a) to c) may be implemented collectively for the production of several devices with graphical elements.

The method may also include, between step a) of production of the stack and step b) of attachment, the following steps:
deposition of a protective layer against a face of the stack opposite the first substrate,
etching of at least the protective layer, delimiting the devices with graphical elements,
cutting of the remaining, unetched layers of the stack in the area of the etched zones at least in the protective layer,
removal of the protective layer.

### BRIEF DESCRIPTION OF THE ILLUSTRATIONS

The present invention will be better understood on reading the description of example embodiments given purely as an indication and in no way restrictively, making reference to the appended illustrations in which:

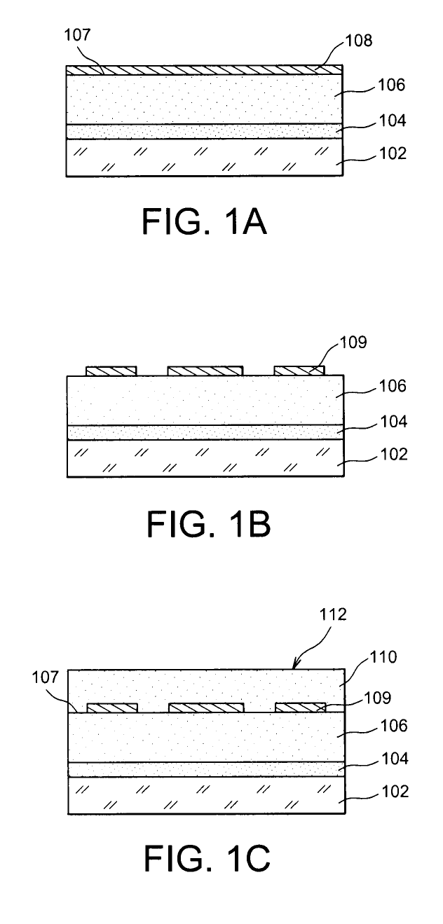

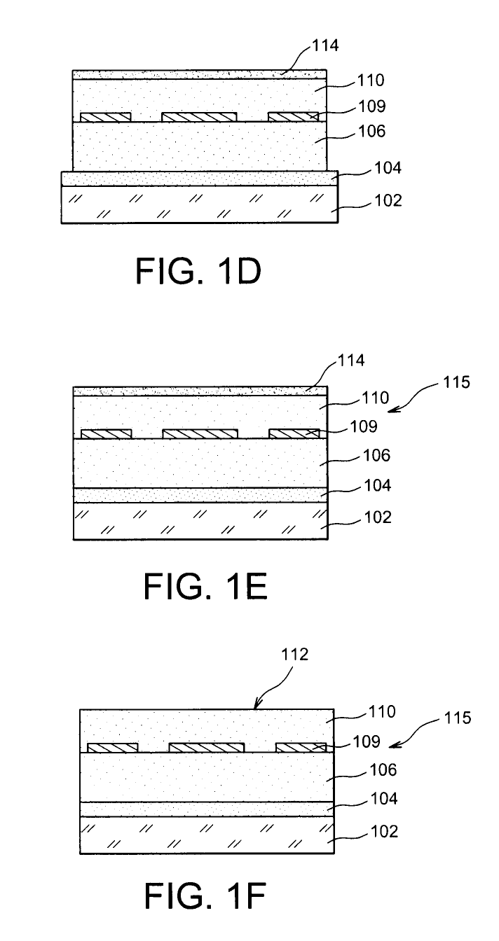

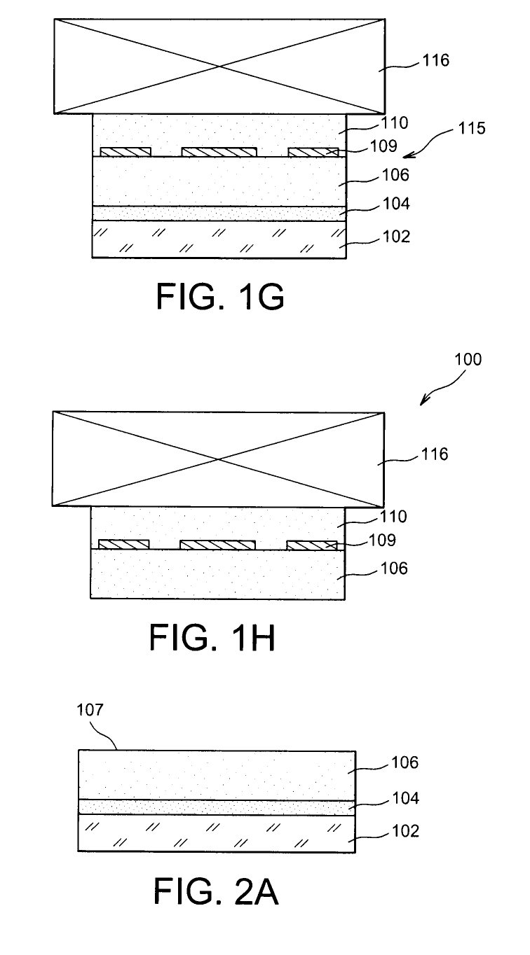

FIGS. 1A to 1H represent the steps of a method to produce a device with a graphical element, forming the subject of the present invention, according to a first embodiment,

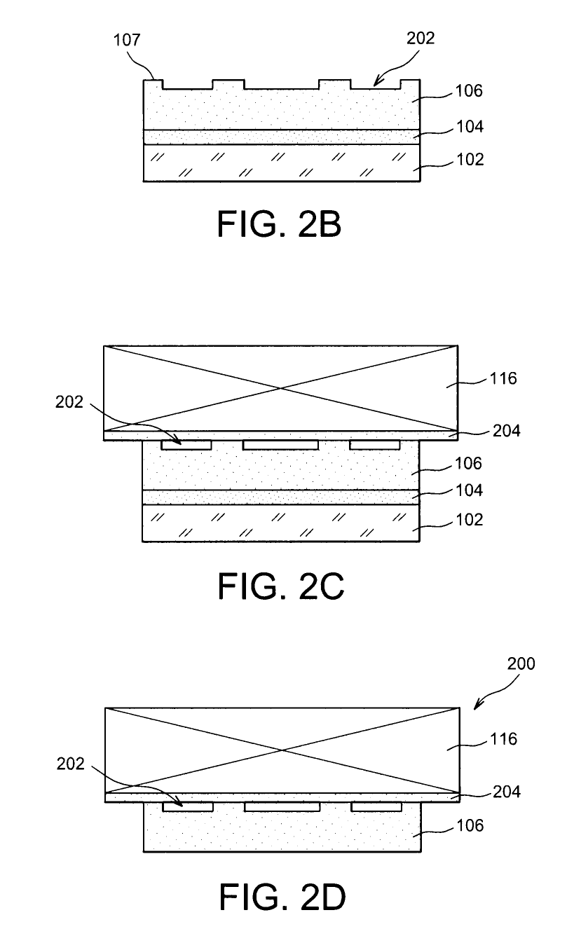

FIGS. 2A to 2D represent the steps of a method to produce a device with a graphical element, forming the subject of the present invention, according to a second embodiment.

Identical, similar or equivalent portions of the various figures described below have the same numerical references, to make it easier to move from one figure to another.

The various parts represented in the figures are not necessarily represented at a uniform scale, in order to make the figures more readable.

The various possibilities (variants and embodiments) must be understood as not being mutually exclusive, and being able to be combined with one another.

### DETAILED ACCOUNT OF PARTICULAR EMBODIMENTS

Reference is firstly made to FIGS. 1A to 1H, which represent steps of a method of production of a device with a graphical element 100 according to a first embodiment.

As represented in FIG. 1A, a stack is firstly produced including a substrate 102 which may be made from a material which may or may not be transparent to light. This substrate may, for example, be a wafer, or a small plate, of diameter equal for example to approximately 200 mm, for example made from a semiconductor such as silicon, or glass. A sacrificial layer 104 is positioned on the substrate 102 and is covered by a protective layer 106.

The material of the sacrificial layer 104 is chosen such that it is able subsequently to cause the substrate 102 to be separated, or detached, from the protective layer 106. The sacrificial layer 104 is, for example, made from SiN_{X}, for example Si₃N₄. In this case, the substrate 102 may be made from a transparent material such as glass in order subsequently that the substrate 102 and the protective layer 106 may be separated by means of laser removal, also called “laser liftoff”, in which the irradiation of the sacrificial layer 104 by a laser beam through the transparent substrate 102 causes a breakdown of this material, thereby detaching the sacrificial layer 104 from the protective layer 106.

In another variant, the sacrificial layer 104 may be made from a fusible material, for example germanium, i.e. a material able to melt above a certain temperature (for example 937° C. in the case of germanium), and thereby cause the protective layer 106 to be separated from the substrate 102. In this variant, the substrate 102 may be made from a non-transparent material. In another variant, the sacrificial layer 104 may be made from porous silicon, which will allow mechanical removal of the sacrificial layer 104 from the protective layer 106, for example through the insertion of a blade between the protective layer 106 and the sacrificial layer 104. In another variant, the sacrificial layer 104, for example made from Ge or Si₃N₄, may be eliminated by chemical attack (with, for example, a solution made from H₂O₂ in the case of a sacrificial layer made from Ge, or a solution made from H₃PO₄ in the case of a sacrificial layer made from Si₃N₄), thereby separating the protective layer 106 and the substrate 102. In these variants not using irradiation by laser beam of the sacrificial layer 104 through the substrate 102, this substrate 102 may be made from a non-transparent material.

The protective layer 106 is, for example, deposited on the sacrificial layer 104 and is made from, for example, an oxide (such as SiO₂) and/or alumina and/or diamond (such as DLC, Diamond-Like Carbon) and/or nitride (such as Si₃N₄) and/or resin and/or at least one dielectric. The thickness of the protective layer 106 is, for example, between approximately 100 nm and 100 μm, such that it is able to protect mechanically the graphical element which will be produced subsequently in the protective layer 106. In order to be able to observe this graphical element through the protective layer 106, this protective layer 106 may be made from an optically transparent material. The degree of transparency of the layer 106 may be variable. Thus, the thickness and material of the layer 106 may be chosen such that the graphical element, which will be produced subsequently, may be visible through the transparent layer 106.

A layer 108, in which the graphical element is to be produced, is positioned on an upper face 107 of the protective layer 106, which is opposite the face of the protective layer 106 in contact with the sacrificial layer 104. This layer 108 may be made from any material, and notably, when the protective layer 106 and/or the object on which the graphical element will be secured are transparent, a material contrasting with the materials which are to be arranged subsequently on the layer 108 (notably the elements referenced 110 and 116 in FIG. 1H), given that the graphical element may be observed through the protective layer 106 and/or the transparent object. It is also possible that the material of the layer 108 may be at least partially opaque at certain wavelengths. For example, if the graphical element is to be seen in visible light (wavelengths of between approximately 380 nm and 780 nm) the layer 108 may be made from metal. The layer 108 may also be made from a material which is contrasting in the range of wavelengths of infrared light (wavelengths of between approximately 780 nm and 1 mm) or ultraviolet light (wavelengths of between approximately 380 nm and 10 nm). The thickness of the layer 108 is, for example, between approximately 10 nm and 1 μm, and preferably between approximately 50 nm and 200 nm.

The layer 108 is then etched in order that remaining portions 109, or the spaces or hollows formed between the etched portions of the layer 108, form the desired graphical element (FIG. 1B). This graphical element represents, for example, data.

In addition, the remaining portions 109 or the spaces formed between the remaining portions may, for example, have dimensions the lower limit of which is equal to the technological limits of the etching techniques used. The etching technique used may be chosen according to the nature of the material of the layer 108.

It is possible to deposit a mask layer, for example made from a mineral material, on the layer 108, to produce an etching of the mask layer in the pattern of the graphical element, and then to etch the layer 108 through the mask made on the layer 108. The masque is then eliminated.

In a variant, it is possible to produce the graphical element by firstly depositing a mask layer, made for example from resin, on the face 107 of the protective layer 106.

This resin layer is then etched in order to form a mask the pattern of which is the reverse pattern of the graphical element. The material which is intended to form the graphical element, for example metal or any other suitable material, and for example similar to the material of the layer 108 described above, is then deposited on the face 107 of the protective layer 106 through the mask, thereby forming the graphical element. Finally, the resin mask is eliminated in order that only the material forming the graphical element remains on the face 107 of the protective layer 106 remains. The portions of material forming the graphical element are therefore similar to portions 109 of the layer 108 forming the graphical element represented in FIG. 1B.

As represented in FIG. 1C, the deposition is first accomplished, followed by the planarisation, for example chemical mechanical planarisation, of a layer 110, or of a stack of layers, made from at least one material compatible with a molecular bonding which will be described below. This layer 110 completely covers remaining portions 109 of the layer 108 forming the graphical element, together with the portions of the face 107 of the transparent layer 106 which are not covered by the remaining portions 109 of the layer 108. The layer 110 is, for example, made from a dielectric material, and can notably be made from an oxide, for example SiO₂. Planarisation enables an upper face 112 of the layer 110 to be made compatible, notably in respect of the roughness and topology of the surface, for subsequent implementation of a molecular bonding of the layer 110, in the upper face 112, with the object which is intended to receive the graphical element. The layer 110 may be produced in order that the thickness of this layer located above the remaining portions 109 of the layer 108 is between approximately 10 nm and 10 μm, and preferably between approximately 10 nm and 1 μm.

Although production of a single device with a graphical element 100 is described in connection with FIGS. 1A to 1H, other devices with graphical elements may also be produced from the stack of layers described above, around device 100. Thus, the previously described steps relative to etching of the layer 108, to deposition of the layer 110 and to planarisation of the layer 110 can be implemented collectively for all the devices produced from the stack of layers 102, 104, 106 and 108, forming in this case a wafer (or slice).

In addition, by planarising the layer 110 collectively for all the devices of the wafer, such planarisation does not then cause any edge effects (the phenomenon of the rounding of the edges) in the edges of the layer 110 of each device, which subsequently facilitates the molecular bonding which will be accomplished in the face 112 of the layer 110.

A protective layer 114, for example made from Si₃N₄, resin, or again carbon (FIG. 1D) is then deposited on the face 112 of the layer 110.

This protective layer 114 enables layers 102, 104, 106, 109 and 110 to be protected from a dry or wet etching accomplished at least through this protective layer 114 to delimit portions of these layers which are to form parts of the device 100.

This etching can also be accomplished through the other layers 110 and/or 106 and/or 104. In the example of FIG. 1D this etching is accomplished through layers 114, 110 and 106.

This etching step therefore enables the device 100 to be delimited “at the surface” from the other devices produced in parallel on the same wafer.

A cut, for example by sawing, is then made through the substrate 102, and possibly one or more of the other layers 104, 106 and 110 if these have not previously been etched, in the area of the delimitations previously made by etching, enabling an individual chip 115 to be obtained (FIG. 1E).

As represented in FIG. 1F, the protective layer 114 is then eliminated. In a variant, it is possible to remove the protective layer 114 prior to the cut made in substrate 102. Steps in preparation for the molecular bonding of the face 112 can then be implemented collectively or individually for the chip 115 or all the chips derived from the initial stack of layers 102, 104, 106, 108 and 110. These preparatory steps can be steps of chemical cleaning of the surface 112 by solutions of the CARO, SC1, etc. type, and/or mechanical preparatory steps, for example a brushing, and/or steps involving UV treatment or ozone treatment, or steps of the plasma type, enabling the molecules of the layer 110 to be activated in the surface 112.

The chip 115 is then bonded molecularly with a second substrate 116 (a substrate on which an oxide layer may previously be positioned), in face 112 of the dielectric layer 110 (FIG. 1G). This second substrate 116 is the object which is intended to include the graphical element, i.e. the object to be identified and/or decorated (the jewel, watch face, precious stone, screen of an electronic device, etc.).

The device 100 is then completed by separating the substrate 102 and the sacrificial layer 104 from the protective layer 106 through the use of one of the separation techniques described above, depending on the nature of the material of the sacrificial layer 104 (removal by laser when the substrate 102 is transparent, and when the material of the sacrificial layer 104 is able to be disintegrated or to undergo degassing, a thermal treatment when the sacrificial layer 104 is made from a fusible material, application of a mechanical stress in order to separate the sacrificial layer 104 mechanically from the protective layer 106, or a chemical attack to eliminate the sacrificial layer 104), as is represented in FIG. 1H.

Reference is now made to FIGS. 2A to 2D, which represent steps of a method of production of a device with a graphical element 200 according to a second embodiment.

In a manner similar to the first embodiment, a stack is first produced including the substrate 102 and the sacrificial layer 104 positioned on the substrate 102 and covered by the protective layer 106 (FIG. 2A). The materials and/or the thicknesses of these layers are, for example, roughly similar to the materials and/or thicknesses described above in connection with the first embodiment. In this second embodiment, the material of the protective layer 106 is preferably a transparent material, for example SiO₂.

However, unlike the first embodiment, the stack of layers produced in this second embodiment does not include the layer 108 in which the graphical element was etched.

In this second embodiment, the graphical element is etched directly in the protective layer 106, in its upper face 107, which is opposite the face in contact with the sacrificial layer 104 (see FIG. 2B). Hollows 202 are therefore made, for example by photolithography and etching, or by etching through a mask temporarily produced on the protective layer 106, in the upper face 107 of the protective layer 106, where these hollows 202 form the graphical element.

It is then possible to deposit, subsequently, on the upper face 107 of the protective layer 106, a protective layer in order to protect layers 106, 104 and 102 from a dry or wet etching, undertaken at least through the protective layer in order to delimit portions of these layers which will form parts of the device 200. This etching can also be accomplished through the other layers 106 and 104.

This etching can be accomplished through the stack at a depth of between approximately 10 nm and 500 nm, and preferably between approximately 10 nm and 100 nm. This step of etching of the protective layer therefore enables the device 200 to be delimited from the other devices produced in parallel on the same wafer. Indeed, in a similar manner to the first embodiment, although the production of a single device with a graphical element is represented in FIGS. 2A to 2D, several other devices with graphical elements, which are unrepresented, are also produced from the previously described stack of layers, through the collective implementation of the steps described in connection with FIGS. 2A and 2B. A cut, for example by sawing, is then made through the substrate 102, and possibly the layers 104 and 106 if these layers have not been etched beforehand, in the delimitations previously made by etching in the protective layer, enabling an individual chip to be obtained, since the protective layer has then been eliminated. Here again, it is possible that the protective layer is removed before the cut is made through the substrate 102.

In a variant embodiment it is possible, prior to the deposition of the protective layer, to deposit a material, such as metal or polysilicon, in the hollows 202. When the protective layer 106 and/or the second substrate 116 are made from an optically transparent material, the deposition of such a material notably allows an improvement of the contrast for observation of the graphical element, which is then formed by the hollows and by the material deposited in the hollows.

A molecular bonding of the protective layer 106 with the second substrate 116, i.e. the object to be identified and/or decorated, is then accomplished, in the upper face 107 of the protective layer 106 including the graphical element (FIG. 2C).

In this second embodiment, the face of the second substrate 116 which is intended to be attached to the protective layer 106 can be previously covered with an oxide layer 204, for example of the same nature as the oxide of protective layer 106, making molecular bonding between second substrate 116 and transparent layer 106 compatible. In addition, bearing in mind the presence of hollows 202 in the face 107 which is intended to be bonded molecularly, this molecular bonding is preferably accomplished in a vacuum chamber.

Device 200 is then completed by separating substrate 102 and the sacrificial layer 104 from the protective layer 106 through the use of one of the separation techniques described above, depending on the nature of the material of sacrificial layer 104 (removal by laser when the substrate 102 is transparent, a thermal treatment when the sacrificial layer 104 is made from a fusible material, application of a mechanical stress to separate the sacrificial layer 104 mechanically from the protective layer 106, or a chemical attack to eliminate the sacrificial layer 104), as is represented in FIG. 2D.

1-14. (canceled)

15. A method for producing a device, with a graphical element, comprising:
a) producing at least one stack including at least one sacrificial layer positioned between at least one first substrate and at least one protective layer, and at least one graphical element produced in a first face of the protective layer opposite a second face of the protective layer, such that the second face is positioned against the sacrificial layer;
b) attaching the stack to at least one second substrate such that the graphical element is positioned between the first substrate and the second substrate; and
c) separating the sacrificial layer from the protective layer.

16. The method according to claim 15, in which the graphical element is produced, during the producing a), by etching at least the first face of the protective layer with a pattern of the graphical element.

17. The method according to claim 16, in which the attaching b) comprises a molecular bonding of the protective layer against the second substrate, implemented under a vacuum.

18. The method according to claim 17, in which the protective layer is made from silicon oxide or silicon nitride, wherein the second substrate includes a face made from silicon oxide or silicon nitride, and wherein the protective layer and the second substrate are bonded molecularly to one another, during the attaching b), in the first face of the protective layer and in the face of the second substrate.

19. The method according to claim 15, which the producing a) of the stack includes:
producing a stack including the sacrificial layer positioned between the first substrate and the protective layer, and a layer which is intended to form the graphical element positioned against the first face of the protective layer;
etching the layer which is intended to form the graphical element with a pattern of the graphical element, where the remaining portions of the etched layer form the graphical element;
depositing a layer covering the protective layer and the graphical element;
planarizing the layer covering the protective layer and the graphical element.

20. The method according to claim 19, in which the layer which is intended to form the graphical element is made from a material which is at least partially opaque to visible light, and/or visible in infrared and/or ultraviolet light.

21. The method according to claim 15, in which the producing a) of the stack includes:
producing a stack including the sacrificial layer positioned between the first substrate and the protective layer, and a mask layer positioned against the first face of the protective layer;
etching the mask layer with a pattern which is the reverse of the pattern of the graphical element;
depositing a material on the first face of the protective layer through the etched mask layer, forming the graphical element;
eliminating the etched mask layer;
depositing a layer covering the protective layer and the graphical element;
planarizing the layer covering the protective layer and the graphical element.

22. The method according to claim 19, in which the attaching b) includes a molecular bonding of the layer covering the protective layer and the graphical element against the second substrate.

23. The method according to claim 19, in which the layer covering the protective layer and the graphical element is made from a dielectric material.

24. The method according to claim 22, in which the layer covering the protective layer and the graphical element is made from silicon oxide or silicon nitride, wherein the second substrate includes a face made from silicon oxide or silicon nitride, wherein the layer covering the protective layer and the graphical element, and the second substrate, are bonded molecularly to one another, during the attaching b), at a level of the face of the second substrate.

25. The method according to claim 15, in which the separating c) includes an application of a mechanical stress between the sacrificial layer and the protective layer, and/or, when the first substrate is made from an at least partially transparent material, and the sacrificial layer from at least one material able to disintegrate, a laser irradiation of the sacrificial layer through the first substrate, and/or, when the sacrificial layer is made from a fusible material, a thermal treatment at a temperature higher than or equal to the melting point of said fusible material, and/or a chemical attack by a solution able to disintegrate the material of the sacrificial layer.

26. The method according to claim 15, in which the protective layer and/or the second substrate are made from at least one optically transparent material.

27. The method according to claim 15, in which a) to c) are implemented collectively for production of plural devices with graphical elements.

28. The method according to claim 27, further comprising, between the producing a) of the stack and the attaching b), the following:
depositing a protective layer against a face of the stack opposite the first substrate;
etching at least the protective layer, delimiting the devices with graphical elements;
cutting the remaining, unetched layers of the stack in the area of the etched zones at least in the protective layer; and
removing the protective layer.
